(19) United States
(12) Patent Application Publication
(10) Pub. No.: US 2017/0109817 A1
(43) Pub. Date: Apr. 20, 2017

(54) SYSTEM AND METHOD FOR FACILITATING FINANCIAL LOANS

(71) Applicant: EINNOVATIONS HOLDINGS PTE. LTD., Singapore (SG)

(72) Inventors: Orlando B. VEA, Makati City (PH); Angelito M. VILLANUEVA, Makati City (PH); Agustin L. SANTIAGO, Makati City (PH)

(73) Assignee: EINNOVATIONS HOLDINGS PTE. LTD., Singapore (SG)

(21) Appl. No.: 15/120,329

(22) PCT Filed: Feb. 17, 2015
(86) PCT No.: PCT/SG2015/050024

§ 371 Date: Aug. 19, 2016

(30) Foreign Application Priority Data
Feb. 21, 2014 (SG) 10201400143U

(51) Int. Cl. G06Q 40/02

(52) U.S. Cl. CPC G06Q 40/025

(57) ABSTRACT

A system of facilitating financial loan comprising a central loan and savings facilitator hosted by a network provider; the central loan and savings facilitator operable to, upon receipt of a request for a loan from a eligible borrower sent via the network provider; authenticate if the request for loan is from a eligible borrower and if so, provides an electronic application interface for the eligible borrower, wherein as a condition for loan approval, the electronic application form comprise a pledge of a savings amount to be made by the eligible borrower, is disclosed.

### FIELD OF THE INVENTION

The present invention relates to a system and method for facilitating financial loans. In particular, the system and method are suited for the facilitation of financial loans using a mobile device and will be described in such context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

In most countries, obtaining a financial loan via an institutional loan provider, such as a bank, for example, require numerous documents such as physical forms to be filled-up, proofs of income to be adhered to and/or other documentary requirements. This makes the loan process not only frustrating but cumbersome to any person trying to obtain a loan. Further, a person taking up a loan usually has to be physically present to complete the documentary requirements. This is often inconvenient and time consuming. Such stringent and complex requirements may sometimes be push factors for potential borrowers to turn to illegal loan sharks, although these potential borrowers may well qualify for legal loans but put off by the complex procedures.

In addition, governments and policy makers around the world seek to achieve a balance between spending, obtaining loans and savings amongst its people.

In light of the above, there exists a need to provide a system and method which promote savings and yet providing financial loans in a fast and efficient manner.

### SUMMARY OF INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

In accordance with an aspect of the invention there is a system of facilitating financial loan comprising:—a central loan and savings facilitator hosted by a network provider; the central loan and savings facilitator operable to, upon receipt of a request for a loan from a eligible borrower sent via the network provider; authenticate if the request for loan is from a eligible borrower and if so, provides an electronic application interface for the eligible borrower, wherein as a condition for loan approval, the electronic application form comprise a pledge of a savings amount to be made by the eligible borrower.

Preferably, the central loan and savings facilitator is operable to be in data communication with a whitelist database, the whitelist database contains information relating to a list of pre-approved eligible borrowers.

Preferably, the central loan and savings facilitator is operable to be in data communication with a regulatory institution associated with the eligible borrower, the regulatory institution operable to assess and pre-approves the eligibility of a borrower.

Preferably, the central loan and savings facilitator is operable to communicate with a loan provider for the approval of loan after determining the eligibility of the borrower.

Preferably, the loan provider is operable to send an electronic application interface to the central loan and savings facilitator for provision to the eligible borrower.

Preferably, the request for loan is received either as a simple text or Short Messaging Service (SMS) text message; or an Unstructured Supplementary Service Data (USSD) messages.

Preferably, the network provider is a telecommunications carrier.

Preferably, the eligible borrower has a mobile subscriber account with the telecommunications carrier.

Preferably, the mobile subscriber account of the eligible borrower is linked to the loan provider.

Preferably, the pledge of savings yield interest, the savings and interest capable of being accumulated and withdrawable at loan maturity.

Preferably, the pledge of savings is linked to an insurance policy.

In accordance with another aspect of the invention there is a method of facilitating financial loan comprising the following steps:—(a.) whitelisting eligible borrowers, the whitelist of eligible borrowers associated with a regulatory institution; (b.) receiving a request for loan; (c.) verifying the request for loan against the whitelist of eligible borrowers; and upon verification (d.) providing a loan application interface for the eligible borrower, wherein as a condition for loan approval, the loan application interface comprises a pledge of a savings amount to be made by the eligible borrower.

Preferably, the step of whitelisting is performed by the regulatory institution.

Preferably, the step of verification is performed by a loan provider.

### BRIEF DESCRIPTION OF THE DRAWINGS

The present invention will now be described, by way of example only, with reference to the accompanying drawings, in which:

FIG. 1 shows a flow diagram of the method for facilitating financial loan in accordance with an embodiment of the invention;

FIG. 2 is a system diagram of a system for facilitating financial loan in accordance with another embodiment of the invention;

FIG. 3 is a system block diagram for facilitating financial loan; and

FIG. 4 is a table showing the additional features that may be performed by a eligible user.

Other arrangements of the invention are possible and, consequently, the accompanying drawings are not to be understood as superseding the generality of the description of the invention.

### DESCRIPTION OF EMBODIMENTS OF THE INVENTION

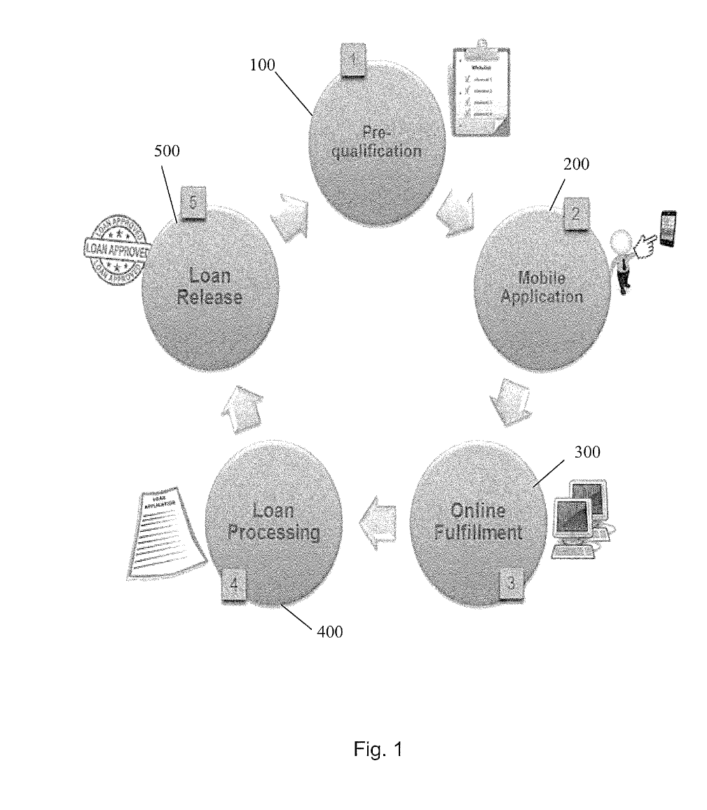

In accordance with an embodiment of the invention and with reference to FIG. 1 there is a method 10 for facilitating financial loans comprising a pre-qualification step 100; an application step 200; a completion/fulfilling step 300; a loan processing and approval step 400; and a loan release step 500. The steps associated with method 10, or part of the steps, may be supported and implemented via a mobile device operable to be connected to a telecommunications network or network operator. The method 10 is especially suited for providing loan to a group of pre-selected employees of a public or private organization. The pre-selection or pre-approval step is done by a regulatory body, which may also be the public organization.

With reference to FIG. 1, the pre-qualification step 100 requires a regulatory body, such as a government agency to pre-qualify or whitelisting all existing employees in their database, and ‘whitelist’ or pre-select the qualified employees to be involved in the ‘mobile loan’ scheme. A prequalification criterion involves, for example, the maintenance of a minimum net salary as stipulated or predefined. Other criteria may include the borrower's debt to income ratio.

The “whitelist” shall contain pertinent details of the employees. The pertinent details include (but is not limited to) demographic data, contact information including mobile identifier or MSISDN, salary details (gross pay, net take home pay etc.) and other personal information. An additional step of certification 120 by a Human Resource (HR) Head may be made before submission to the loan provider such as a bank. The bank servicing branch assigned to the government agency will be the designated loan provider to process the upload into a Savings and Loan server (SLS). Once uploaded, the white-listed employees will be eligible as “pre-qualified” borrowers into the Loan Program.

The loan provider, after uploading the pre-qualified or pre-approved employee list, will inform the government agency that the whitelisted “pre-qualified” employees may now apply for loan (should they wish) using their mobile device for the loan program. The mobile device comprises a dedicated software application for the user to make requests for a loan electronically. The “mobile application” step serves as the first electronic step for the qualified employee/borrower to signify his intention to avail himself to the loan program.

By way of an example, the employee/borrower needs to the send an request for loan, which is in the form of a SMS message with the following message syntax:—

“LOAN <space> EMPLOYEE NUMBER <space> AGENCY CODE” and send to 5363 (server code and identifier).

The SLS will validate the SMS message sent by checking the whitelisted database and additional authentication methods if necessary. If the potential borrower is found to meet the validation, a confirmation reply will be sent to the potential borrower. The reply message is typically in the form of a text message:—

“Thank you. You have been pre-qualified under the Mobile Loan-Saver Program. A link will be sent to your registered email address to complete your application. Your Passcode for the online application is XXXXXX. Thank you.” (Date) (Ref #)

The potential borrower will then need to enter this “passcode”, which may be a series of randomly generated alpha-numeric letters/numbers for the potential borrower to access a secure electronic interface which may be an online form in order to complete his loan application.

The Online Fulfillment/Completion step 300 for completing the Loan Details involves the potential borrower accessing an online form via the secured URL link sent to his registered email address. After entering the “passcode” which was sent to this mobile device earlier, he is brought to the online application screen where he needs to input the following information for the loan registration to be completed:—
(i) Intended Loan Amount;
(ii) Intended Loan term for either 12, 24, 36 months or other loan term as specified/predetermined by both the regulatory body and the loan provider; and
(iii) Pledge a savings amount, known as the “AutoSave” amount based on the options from a minimum to a maximum per pay day. This is important condition to ensure that while the loan is made available to a potential borrower, the potential borrower is to make certain amounts of savings as part of the terms and conditions for the loan to be approved.

After the potential borrower decides on the above three information and inputs them accordingly, the SLS will calculate the indicative and projected net loan proceeds, (which will be the net loan amount after all charges and any service fees have been deducted). As a note, this is NOT yet the final approved loan as it will still undergo the loan credit process of the approving loan provider or institution (e.g. the Land Bank).

The borrower will also be asked to agree to all terms and conditions, which may be in the form of a user interface provided as an “I Agree” button; Disclosure Form, Promissory Note and the other required forms available online, and signing off on the loan via the e-Signature section before clicking on the “Submit” button in the form.

The borrower will also have the option to print the entire form should he wish to retain a copy.

The processing and approval step 400 involves the loan provider accessing the electronic loan application to process all submitted online application forms; review the loan; and do an internal audit on the borrower/applicant. If the borrower passes the credit checking he will process the loan in the system as “processed” and locks in the loan details.

The approval step involves the loan provider bank (presumably someone of higher rank action on behalf of the bank) accessing the electronic loan application and checking on all loan applications processed for his review. If everything is in order, he will “approve” the loan in the SLS system.

An SMS/text message will automatically be sent to the borrower informing him that his loan was approved, with the following message:

“Congratulations, your Mobile Loan-Saver application has been approved. Please wait for three banking days for the loan proceeds to be credited to your Land Bank payroll account. Thank you.” (Date) (Ref #)

The loan release step 500 comprises all loans approved for the day which will be processed at end-of-day, and downloaded from the system as reference and records. This file will be processed and uploaded into the loan providers' CASA System the next day for crediting of the payroll account of the borrower/employee of the net loan proceeds.

The borrower will then receive the following text/SMS message once the loan release step 500 is completed:—

“Congratulations, your Mobile LoanSaver account has been approved. Kindly wait from one to three banking days for the loan proceeds to be credited to your Land Bank payroll account. Thank you.” (Date) (Ref number)

The loan amount will be deposited to the “CASA” account the borrower has with the loan provider. Such accounts include savings account, current account and any other accounts the loan provider may introduce from time to time and may be alone or jointly applied with any other person(s). It is to be appreciated that an eligible borrower should have a payroll account with the loan provider to be availed of loan provision service.

In accordance with another embodiment of the invention there is a system 20 for linking a regulatory institution 30 and a loan provider 70 with a network provider 50, so as to provide a targeted service to one or more users. An example of such a targeted service is the facilitation and/or provision of financial loan to personnel associated with the regulatory institution 30, such as, but not limited to employees of the regulatory institution.

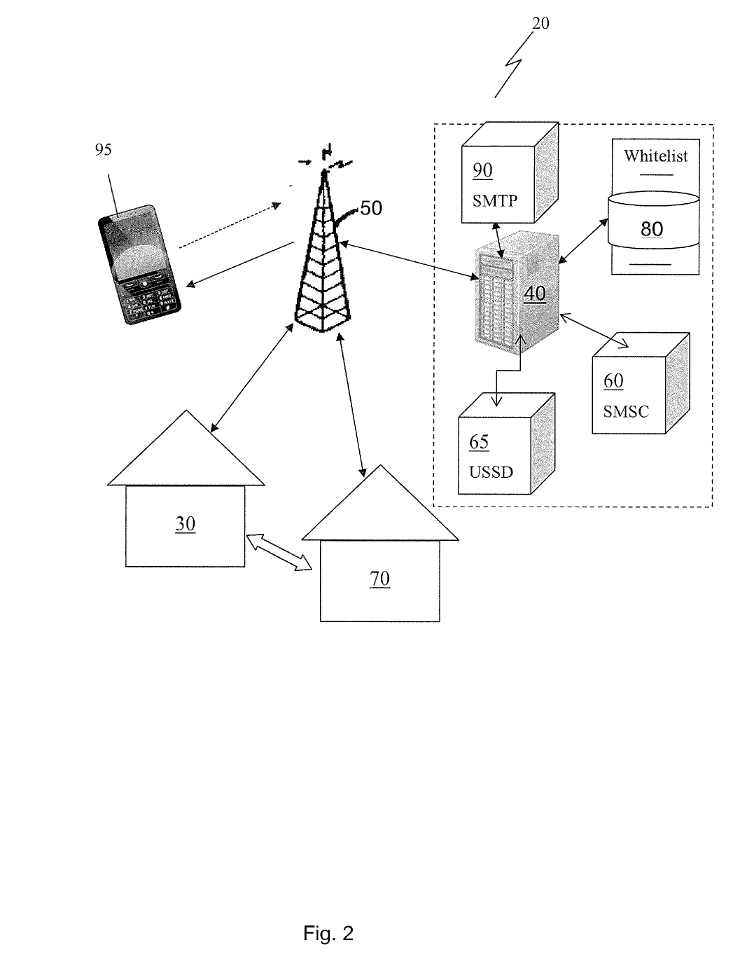

With reference to FIG. 2, the system comprises a Savings and Loan server (SLS) 40 hosted by the network provider 50, the SLS 40 operable to receive a request for loan from a potential borrower. Network provider 50 may further host a communication server, such as a SMS centre 60 or a USSD server (gateway) 65. The SMS center 60 and/or USSD server 65 are operable to receive loan requests in the form of simple text messages or USSD messages, and responsible for sending text, SMS, and/or USSD notifications to the potential borrower.

The network provider 50 may be a telecommunications carrier. Telecommunications carrier 50 provides a variety of services, including the generation and maintenance of subscriber accounts including both prepaid and postpaid subscriber accounts. Such subscriber accounts and information may be stored in a database 80. The SLS 40 is within a proxy gateway server for connecting to a network such as the Internet. The request for loan may be in the form of simple text or Short Messaging Service (SMS) text message,

Unstructured Supplementary Service Data (USSD) messages or any other form of an electronic signal/message.

The regulatory institution 30 is a public or private institution arranged to provide pro-approval white-list of a list of eligible borrowers for uploading onto the database 80.

The SLS 40 is operable to be in data communication with the communication server and the database 80. The SLS 40 may comprise a web-based application with a direct connection to the SMSC 60 for the text based messaging functionalities. The SLS 40 is operable to be in data communication with the regulatory institution for receiving a whitelist of personnel eligible for obtaining loan.

In an embodiment, the regulatory institution 30 is arranged with the loan provider 70 to provide payroll services to the personnel of the regulatory institution 30. The loan provider 70 comprises a depository payroll database which is arranged in data communication with the regulatory institution 30 for purpose of crediting salary to the personnel payroll accounts held by the loan provider 70.

The SLS 40 is operable to perform the following functions relating to the update of database 80:—
Monitor and maintain Member/Borrower information and status
Monitor Members'/Borrower's savings and loans information
Process loan applications, i.e. by liaising with the loan provider 70 and regulatory institution 30
Allow for configurable and flexible loan processing requirements, where applicable
Allow for loan calculation based on Capital, Contribution, Shares, Savings, or other defined basis
Allow for flexible and configurable loan deduction and fees (includes loan interest, various fees and payment frequency)
Accept savings deposits and loan payments

In addition, SLS 40 is operable to provide and handle the following:

Interfaces with the online loan application form provided by the loan provider 70.

Integrated with an SMTP architecture 90 for email notifications

Interface with text-based loan payments received via SMSC 60

Accept from and send information to loan provider 70 (i.e. Land Bank) server/portal and Loans database.

Interface with the SMSC 60 and database 80

Allow text and web-based inquiry of loan balances

The system is next described in the context of its application and usage.

Before a request for loan is received, the regulatory institution 30, such as a government agency, prequalifies or pre-approves personnel (employees) who are eligible to obtain loans based on step 100 as described in the earlier embodiment. A whitelist is then generated for employees or personnel who are eligible. The whitelist comprising the pre-approved personnel are uploaded onto the database 80 via the loan provider 70 and/or financial institution servicing the regulatory institution 30.

Once pre-approved, an eligible borrower may utilize a mobile device 95 to send a loan request to the SLS 40. A

Prior to use, the mobile device 95 is checked if it has been registered as a subscriber of the system 20 via checks on an identifier, such as, but not limited to, the MSISDN of the mobile device 95. Other methods as known to a skilled person may also be used to check if the mobile device 95 is properly registered. If the mobile device 95 is not a subscriber, the user of mobile device 95 is prompted a message by the software application to subscriber as a user.

If the mobile device 95 is already registered as a subscriber of the system 10, the user of mobile device 95 may send the loan request as a SMS/USSD message, and the electronic online registration form is accessible via an Internet host of the loan provider 70. Access to the electronic online registration form may be via the telecommunications carrier 50 through a mobile data plan or via other means for accessing the Internet.

Once the SLS 40 receives the loan request in the form of a loan request SMS/USSD message, the MSISDN of the mobile device 95 and/or other details are checked against the whitelist database 80. The SLS 40 will validate the loan request sent by checking the whitelisted database 80 and using additional authentication methods if necessary. If the user is found to meet the validation, a confirmation reply will be sent to the borrower. The reply message may be in the form of a text message:—

“Thank you. You have been pre-qualified under the Mobile Loan-Saver Program. A link will be sent to your registered email address to complete your application. Your Passcode for the online application is XXXXXX. Thank you.” (Date) (Ref #)

In this regard, the email address is an example of a second identifier. The second identifier may alternatively be information related to social network accounts or mobile wallet of the user (where applicable).

The potential borrower will then need to enter this “passcode”, which is a series of randomly generated numbers for the potential borrower to access a secure online form in order to complete his loan application in accordance with the application step 200.

The secured online form may be filled up with details and information in accordance with the Online Fulfillment/Completion step 300 as described. It is to be appreciated that the loan amount is coupled with a pledge amount to encourage compulsory savings as part of the terms and conditions for obtaining the loan.

The loan application is then sent to the loan provider 70 for processing and approval in accordance with step 400. Once approved, the loan amount will be credited to the designated account of the borrower in accordance with the loan release step of step 500.

The designated account of the borrower may be in the form of electronic wallet account. Alternatively, the payroll depository account that the borrower has with the loan provider 70 may be utilized for crediting of the loan amount. A separate savings account may be created for the savings pledge to be deposited.

Salient advantages related to the described embodiments are as follows:—

The system and method as described is a full-electronic salary Loan facility coupled with an AutoSaving component. The system and method is suited to be implemented in partnership with a loan provider such as a national/government bank of a country. Such arrangement is suitable, but not limited for government employees.

The invention is suited to be implemented with an existing telecommunications carrier which is operable to be in data communication with the loan provider's depository payroll base.

The system 20 provides each pre-selected borrower with an electronic user interface, access to a salary loan and savings product backed by his payroll account with the loan provider 70. The differentiating factor offered by the system and method is that it is fully-electronic, paperless and fast in terms of processing time. The payment of the loan may be automatically debited from the borrower's payroll account with the loan provider 70 every pay day for greater convenience. Borrowers may also easily keep tabs on their payments and savings through timely SMS notifications sent via the network provider 50.

The system and method is further advantageous in that the processing time is greatly reduced due to the pre-approval step. Compared to the prior art manual process, a financial loan may be processed and the proposed credit verified as fast as one day up to three banking days. It is then immediately credited to the borrower's payroll account with the loan provider 70. The borrower may also withdraw the loan via an ATM machine. In particular, the pre-approval step performed by the regulatory institution, which “white-list” prequalifying the employees for their respective agencies, reduce documentary requirements and hence the overall the time to apply for the loan. It is all electronic (SMS and Online), thus saving on time and effort to submit the loan requirements. The prequalifying step will sift out unsuitable candidates who do not qualify for a loan.

All account credits may be accessed through a borrower's account with the loan provider and the borrower can check their balances anytime, anywhere just by texting; or via a dedicated mobile software application.

Since manpower is reduced, the loan provider 70 may be able to offer relatively lower interest rates compared to market rates. The loan is hence an income booster with the offering of a better than market interest rate for the pre-selected potential borrowers (employees).

The system and method may be made available to various regulatory institutions, such as public government bodies, or private bodies.

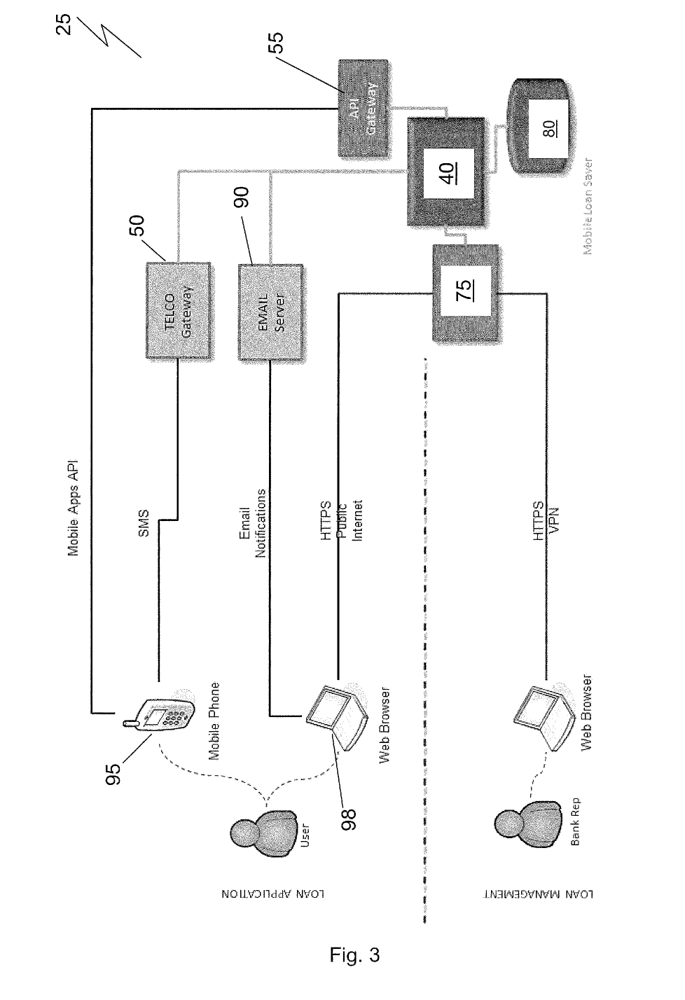

In another system embodiment 25 as shown in FIG. 3, where like numerals reference like parts, the mobile device 95 may be installed with a dedicated mobile software application depending on the particular model of the mobile device 95. For a typical mobile device 95 which is a smartphone 95 running on an iPhone™ or Android™ platform, the dedicated software application may be an “app” as colloquially known.

An eligible borrower having a smartphone 95 which has integrated computing functions, Internet access and capable of downloading an ‘app’ to avail himself to the loan service. The mobile app is operable to be in data communication with the SLS 40 via an API gateway 55.

The eligible borrower can apply via the mobile app as a new borrower, by registering his mobile number (MSISDN). The number will then be matched by the database 80 and if validated, he can proceed to apply for the loan. The app may provide user interface (electronic interface) in the form of menu options to apply for the loan—following the same process of typing in the LOAN AMOUNT, LOAN TERM AND AUTO-SAVE AMOUNT; provide user-interface for accepting the terms and condition; and submit the same. In such as case, the user interface, menu options of the app functions as the Online Application form. Once approved, he will still get the usual SMS notifications for all loan activity.

The benefit of using the mobile app is that a borrower/saver may log-in anytime in the mobile app to check his account—for status, loan amortizations, remaining balance, instead of the usual SMS/text-based process in this document which will still be available for customers with feature phones (non-smartphone).

In the embodiment of FIG. 3, the eligible borrower may also access the SLS 40 via a web portal 75. Web portal 75 also provides access to the loan electronic form. The user may then use a separate computing device 98 to enter the relevant details associated with step 400. It is to be appreciated that should the eligible borrower be a subscriber of a data plan, he/she may proceed to also utilize the smartphone 95 for accessing the loan electronic form via web portal 75.

In another embodiment, the auto-savings component may yield savings account interest, which would be accumulated and withdrawn at loan maturity. Such an arrangement functions similar to an insurance policy, which provides some form of pay-out in the event of the borrower's untimely death or incapacitation due to accident. In such event, the entire loan is fully paid and the total accumulated savings with interest will accrue to the immediate family members of the borrower.

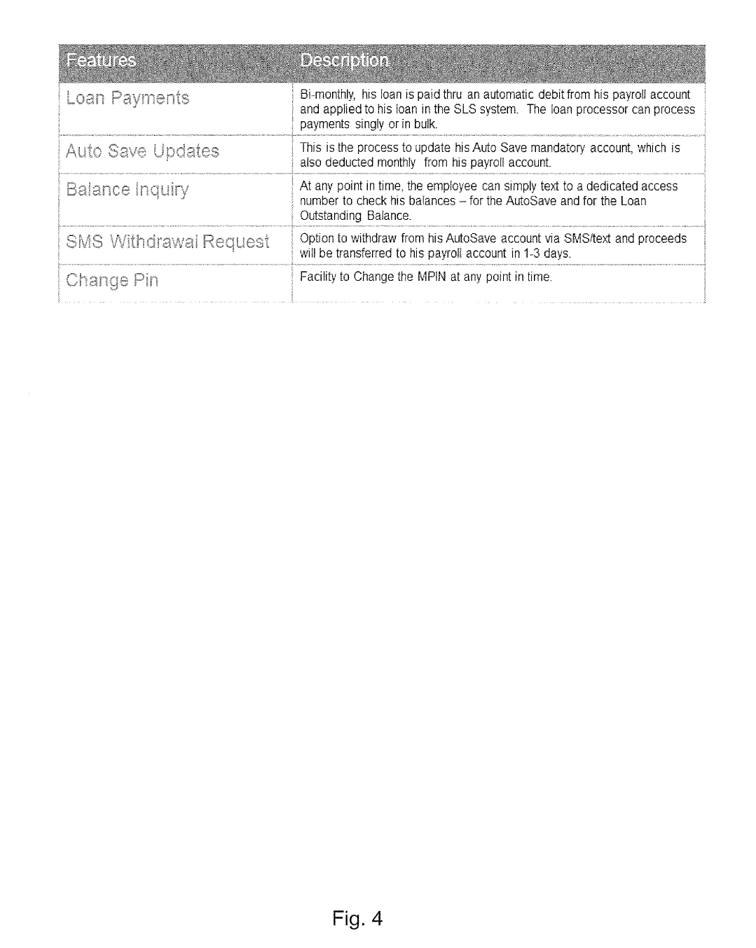

FIG. 4 shows a case example, in the form of a table, of add-on additional features that may be utilized by a user.

It should be appreciated by the person skilled in the art that variations and combinations of features described above, not being alternatives or substitutes, may be combined to form yet further embodiments falling within the intended scope of the invention. In particular, the embodiments depicted in FIG. 2 and FIG. 3 may be combined.

1. A system for facilitating financial loan comprising:—
a central loan and savings facilitator comprising a server, the central loan and savings facilitator hosted by a network provider;
a mobile device associated with a first identifier;
wherein the central loan and savings facilitator operable to:—
receive from the mobile device an electronic loan request in the form of a Short Messaging Service (SMS) text message having a specific syntax or an Unstructured Supplementary Service Data (USSD) message having the specific syntax,
wherein the specific syntax comprises a second identifier;
authenticate, upon receipt of the electronic loan request, whether the user is a pre-approved borrower at least by way of the first identifier of the mobile device and the second identifier of the specific syntax and if so, provides an electronic application interface for the pre-approved borrower.

2. The system according to claim 1, wherein the central loan and savings facilitator is operable to be in data communication with a whitelist database, the whitelist database contains information relating to the pre-approved borrower.

3. The system according to claim 2, wherein the central loan and savings facilitator is operable to be in data communication with a regulatory institution associated with the pre-approved borrower, the regulatory institution operable to assess and pre-approves the eligibility of a borrower.

4. The system according to claim 3, wherein the specific syntax comprise a loan keyword, an identifier associated with the pre-approved borrower, and an identifier associated with the regulatory institution.

5. The system according to claim 1, wherein the central loan and savings facilitator is operable to communicate with a loan provider for the approval of loan after determining the eligibility of the borrower.

6. The system according to claim 5, wherein the loan provider is operable to send an electronic application interface to the central loan and savings facilitator for provision to the pre-approved borrower.

7. The system according to claim 1, wherein the electronic application interface is provided to the pre-approved borrower by way of a link that is sent to a third identifier associated with the pre-approved borrower

8. (canceled)

9. The system according to either claim 7, wherein the pre-approved borrower is able to access the electronic application interface by way of at least the link that is sent to the third identifier and a passcode that is sent upon authentication to the mobile device associated with the first identifier.

10. The system according to claim 1, wherein as a condition for loan approval, the electronic application interface comprises a pledge of a savings amount to be made by the pre-approved borrower.

11. The system according to claim 1, wherein the network provider is a telecommunications carrier.

12. The system according to claim 11, wherein the pre-approved borrower has a mobile subscriber account with the telecommunications carrier.

13. The system according to claim 12, wherein the mobile subscriber account of the pre-approved borrower is linked to the loan provider.

14. The system according to claim 1, wherein the pledge of savings yield interest, the savings and interest capable of being accumulated and withdrawable at loan maturity.

15. (canceled)

16. A method of facilitating financial loan comprising the following steps:—
(a.) whitelisting a list of pre-approved borrowers, the list of pre-approved borrowers associated with a regulatory institution;
(b.) receiving a request for loan by a server from an pre-approved borrower sent by way of a mobile device associated with a first identifier, wherein the request for loan is received as one of the following: a Short Messaging Service (SMS) text message having a specific syntax, an Unstructured Supplementary Service Data (USSD) message having the specific syntax;
(c.) authenticating the request for loan against the whitelist of pre-approved borrowers at least by way of the first identifier of the mobile device and a second identifier within the specific syntax; and upon authentication
(d.) providing a loan application interface for the pre-approved borrower, wherein as a condition for loan approval, the loan application interface comprises a pledge of a savings amount to be made by the pre-approved borrower.

17. The method according to claim 16, wherein the step of whitelisting is performed by the regulatory institution.

18. The method according to claim 16, wherein the specific syntax comprise a loan keyword, an identifier associated with the pre-approved borrower, and an identifier associated with the regulatory institution.

19. The method according to claim 16, wherein the loan application interface is provided to the pre-approved borrower by way of a link that is sent to a third identifier associated with the pre-approved borrower.

20. (canceled)

21. The method according to claim 19, wherein the pre-approved borrower is able to access the electronic application interface by way of at least the link that is sent to the third identifier and a passcode that is sent upon authentication to the mobile device associated with the first identifier.

22. The method according to claim 16, wherein as a condition for loan approval, the electronic application interface comprises a pledge of a savings amount to be made by the pre-approved borrower.

23. A central loan and savings facilitator comprising a server, the central loan and savings facilitator hosted by a telecommunications carrier and operable to:—
receive and process a request for a loan from a pre-approved borrower sent by way of a mobile device associated with a first identifier via the telecommunications carrier,
wherein the request for loan is received as one of the following: a Short Messaging Service (SMS) text message having a specific syntax, an Unstructured Supplementary Service Data (USSD) message having the specific syntax;
authenticate if the request for loan is from an pre-approved borrower at least by way of the first identifier of the mobile device and a second identifier within the specific syntax and if so, provides an electronic application interface for the pre-approved borrower.

24. (canceled)
